(19) United States
(12) Patent Application Publication
(10) Pub. No.: US 2010/0285181 A1
(43) Pub. Date: Nov. 11, 2010

(54) UNCONVENTIONAL EDIBLE FOOD PRODUCTS

(76) Inventors: RAYMOND KENNETH MOORS, Chino, CA (US); Edward A. Dominguez, La Verne, CA (US)

Correspondence Address: RAY MOORS, 3637 Leticia Way, Chino, CA, 91710, US

(21) Appl. No.: 12/774,582

(22) Filed: May 5, 2010

Related U.S. Application Data
(60) Provisional application No. 61/176,577, filed on May 8, 2009.

(51) Int. Cl. A23L 1/31; A23P 1/00

(52) U.S. Cl. 426/104

(57) ABSTRACT

A food product having an unconventional design, such as that resembling meat from a prehistoric animal, may be made by attaching meat to a large beef rib bone. The beef rib bone may be made to resemble a rib from a prehistoric animal.

### CROSS-REFERENCE TO RELATED APPLICATIONS

This application claims the benefit of priority to U.S. Provisional patent application number 61/176,577, filed May 8, 2010, herein incorporated by reference.

### BACKGROUND OF THE INVENTION

The present invention relates to food products and, more particularly, to food products having unconventional designs, such as being designed to resemble meat from a prehistoric animal.

Consumers currently do not receive the option of enjoying food products that do not resemble conventional products.

As can be seen, there is a need for unique appearing food for consumers to enjoy.

### SUMMARY OF THE INVENTION

In one aspect of the present invention, a food product comprises a meat holder having the appearance of an animal bone; and meat adhered to the meat holder, wherein the food product does not resemble a naturally occurring available food product.

In another aspect of the present invention, a food product comprises a clean beef rib bone; an edible adhesive applied to the beef rib bone; and meat adhered to the beef rib bone via the edible adhesive, wherein the food product does not resemble a naturally occurring available food product.

These and other features, aspects and advantages of the present invention will become better understood with reference to the following drawings, description and claims.

### BRIEF DESCRIPTION OF THE DRAWINGS

FIG. 1 is an example of a cow rib bone usable in preparing a food product according to the present invention;

FIG. 2 is a meat product usable in preparing a food product according to the present invention; and

FIG. 3 is a food product according to one example of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides food products having unconventional designs, such as designs resembling meat from a prehistoric animal. In one embodiment of the present invention, a beef rib bone may be made to resemble a rib from a prehistoric animal.

The present invention relates to a large portion of beef, fish, fowl, pork, or other edible meats, or a combination thereof, glued by edible adhesive to a large meatless beef rib bone, in order to make the meatless beef rib bone resemble a part from a prehistoric animal. The present invention may comprise a large beef rib bone selected onto which meat can be applied and adhesively glued with edible adhesive in a manner that no modern beef, fish, fowl, swine, or other animals provide.

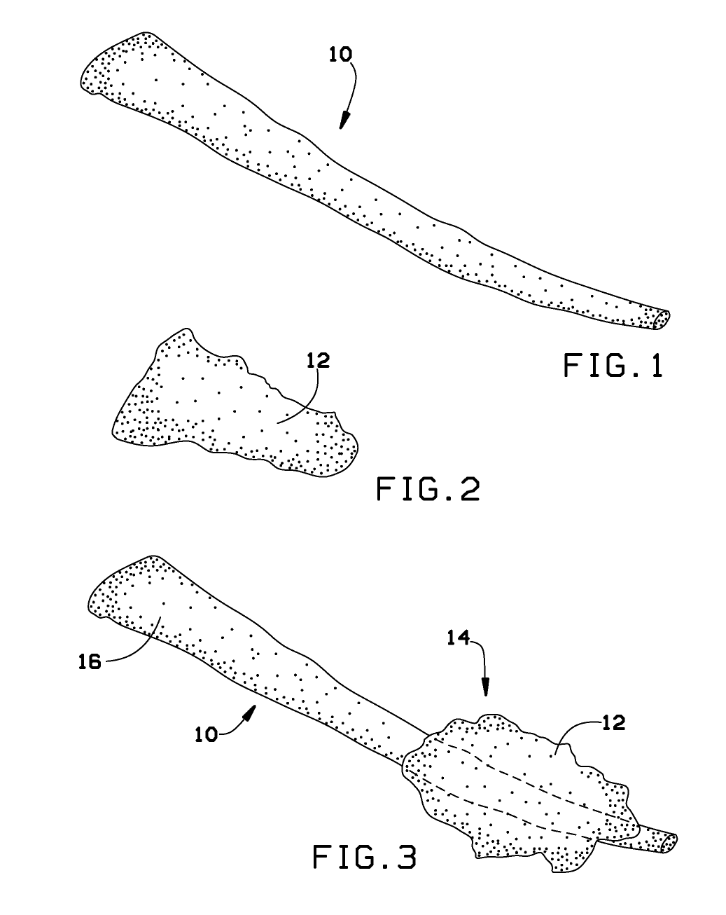

Referring to FIGS. 1 through 3, a meat holder, such as 12-18 inch long beef rib bone 10, typically a 14 inch long beef rib bone, can be selected wherein the meat may be cut away from the bone. Meat 12 from beef, such as U.S.D.A. select, prime, or choice, or selected fowl, fish, or pork may be cut and placed around the large beef bone. Edible adhesive (not shown) may be placed upon the large beef bone and the meat, for example about 16 ounces, may be secured to the large beef bone and allowed to cure till fully secured to the bone. The resulting food product 14, according to an embodiment of the present invention, may resemble a prehistoric animal rib. The rib bone 10 and the attached meat 12 can be configured such that part of the meat 12 is attached to the entire bone 10, or partially attached to only part of the bone 10, for example, the top portion of the bone 10, such that there is a part of the rib bone that is meatless and can act as a handle 16 to comfortably hold the rib and enjoy eating the meat.

The food item of the present invention, which may be called “Dino-Rib”, may be, for example, a combination of U.S.D.A. Choice beef that is a male animal raised for human consumption and then fed grain and corn in a stockyard in order to achieve a certain fat to meat ratio that the United States Department of Agriculture deems to be rated as “Choice”. However, a male beef animal does not have as large a rib bone as does the corresponding female cow. So, the large female cow bone can be stripped of all meat, and meats can then attached to it using edible adhesive glue binding product, such as carragennan, making a comminuted meat product.

While the above example discusses a beef product, other products may be contemplated within the scope of the present invention. For example, chicken may be used to create a product which may be called, for example, a “chick-o-dactyl”. Lamb may be used to create a product which may be called, for example, a “Lamb-a-don”. Other uses of beef, fish, fowl, pork, or other edible meats may be used in various embodiments of the present invention.

Examples of the edible adhesive may be similar to those described in U.S. Pat. No. 3,644,128, and may be a protein enriched meat food product of improved texture, composition, and nutritional value which comprises from about 95.0 to about 99.96 percent by weight of product of comminuted meat solids base and from about 5.0 to about 0.04 percent by weigh of product of an edible nontoxic proteinaceous binder composition. The protein of the meat product may be water-soluble and comprising principally spray-dried plasma form the blood of slaughtered livestock. However, this protein binder also includes less than 1 percent and preferably from about 0.05 to about 0.01 percent by weight of a unique edible anticoagulant which remains in the plasma to complex the protein binder prior to use. This organic material is known popularly as carrageenan.

In order to achieve a unique food product that resembles that of no modern animal but rather that from a prehistoric animal the following process can be followed. A rib bone form an older cow may be selected. In the meat processing industry, a cow, which is usually a milk producing animal, is allowed to age and produce larger rib bones than that of its counterpart, the steer, which is raised solely for human consumption. Consequently, a rib from a cow will be substantially larger than that of a steer. As part of the present invention, a large cow rib measuring 14 inches to 24 inches in length may be selected form a processed cow. The cow rib bone may be then stripped of its meat, and then attached to that cow rib may be a large weight of meat, for example 1 pound or more of U.S.D.A. Choice (or better grade) beef, fish, pork, fowl, or a combination thereof to produce a product that is of high quality meats and larger than any rib product presently known in modern times and, thus for the consumer, resembles a food product form a prehistoric animal. Consumers would eat the present invention, which will provide the consumers with a dining experience that resembles that of a prehistoric meal.

While the above description uses a real animal, for example, a cow rib bone, embodiments of the present invention may be designed with a food safe artificial bone. For example, various bone-like U.S.D.A. approved material, such as porcelain or manufactured stone, silicone coated metal, or the like may be made to resemble a large animal bone to which meat may be attached.

While the above description describes using meat on the animal bone, other food products may be attached to the bone, either a real bone or an artificial bone. For example, a potato, tofu, or other food product may be attached to the bone.

It should be understood, of course, that the foregoing relates to exemplary embodiments of the invention and that modifications may be made without departing from the spirit and scope of the invention as set forth in the following claims.

We claim:

1. A food product comprising:
a meat holder having the appearance of an animal bone; and
meat adhered to the meat holder,
wherein the food product does not resemble a naturally occurring available food product.

2. The food product of claim 1, wherein the meat holder is a beef rib bone.

3. The food product of claim 1, wherein the meat holder is a cow rib bone.

4. The food product of claim 1, wherein the meat is U.S.D.A. choice or better meat.

5. The food product of claim 1, wherein the meat is selected from the group consisting of beef, fish, fowl and pork.

6. The food product of claim 1, wherein the meat is adhered to the meat holder with an edible adhesive.

7. The food product of claim 1, wherein the food product resembles a rib from a prehistoric animal.

8. The food product of claim 1, wherein the meat holder is a bone with its meat removed before adhering the meat thereto.

9. A food product comprising:
a clean beef rib bone;
an edible adhesive applied to the beef rib bone; and
meat adhered to the beef rib bone via the edible adhesive,
wherein the food product does not resemble a naturally occurring available food product.

10. The food product of claim 9, wherein:
the meat is U.S.D.A. choice or better meat; and
the meat is selected from the group consisting of beef, fish, fowl and pork.
